(19) United States
(12) Patent Application Publication
(10) Pub. No.: US 2008/0090199 A1
(43) Pub. Date: Apr. 17, 2008

(54) Dental Optical Diagnostic Apparatus

(75) Inventors: Kunitoshi Noguchi, Saitama (JP); Fumio Nishiyama, Saitama (JP); Kazunobu Ogawa, Saitama (JP); Yukinori Mihata, Saitama (JP); Masashi Shimamura, Saitama (JP); Shusuke Kimura, Saitama (JP)

Correspondence Address: HAUPTMAN KANESAKA & BERNER, 1700 Diagonal Road, Suite 310, Alexandria, VA, 22314, US

(73) Assignee: KABUSHIKI KAISHA MORITA TOKYO SEISAKUSHO, Saitama-shi (JP)

(21) Appl. No.: 11/666,243

(22) PCT Filed: Nov. 15, 2004
(86) PCT No.: PCT/JP04/17310

§ 371 Date: Apr. 25, 2007

(51) Int. Cl. A61C 3/00

(52) U.S. Cl. 433/29

(57) ABSTRACT

In the field of dental care, diagnoses have been and being made by means of X-ray images, visual observation, explorer, palpation, fluorometery, insertion of a pocket probe and observation, observation by means of a root canal meter and the use of a Doppler flood flowmeter. However, such diagnoses are invasive and not very clear and three-dimensional X-ray CT apparatus that are being used for diagnoses are very large and complex. Additionally, OCT apparatus for obtaining optical tomographys by using reflection light that are being used by ophthalmologists give rise to problems because of the profile of the detection probe and operability when such an apparatus is used in an oral cavity that contains hard tissues such as teeth and soft tissues such as gingiva for dental care. The present invention dissolves the above identified problems and provides a non-invasive and high resolution dental optical diagnostic apparatus. A dental optical diagnostic apparatus (1) according to the invention comprises a means (30) for generating guide light to irradiate the dental part of a subject for viewing, visible light for picking up a surface image and signal light of low coherence light for diagnosing the dental part, a camera (69) for picking up a surface image of the dental part, an OCT means for acquiring an optical tomography and an image display section (5) for displaying the obtained images.

### TECHNICAL FIELD

This invention relates to a diagnostic apparatus in the field of dental care. More particularly, the present invention relates to an optical diagnostic apparatus using OCT (optical coherence tomography).

### BACKGROUND ART

Conventionally, diagnostic apparatus and diagnostic methods have been and being appropriately and selectively used for diagnoses in the field of dental care according to the location and the symptom of the affected part. For instance,

[1] A dental carious (decayed tooth) on the surface of either of two adjacent teeth is detected and diagnosed by means of an X-ray image or visually, irradiating the site with light by means of a lamp,

[2] A decalcification of dental enamel (initial dental carious) and a calcification (feasibility of re-calcification) are diagnosed by means of visual observation, palpation using an explorer or fluorometry using a laser-excited fluorometer,

[3] An initial carious of dentin and the progress thereof are diagnosed visually, by means of palpation using an explorer or fluorometry using a laser-excited fluorometer,

[4] An inflammatory part of gingiva and the progress thereof are diagnosed by means of an X-ray image,

[5] The profile of a periodontal pocket is diagnosed visually or by means of a multi-angular X-ray image and the depth thereof is measured and diagnosed by inserting a pocket probe into the pocket,

[6] A carious part of an area hidden in a periodontal pocket is diagnosed visually or by means of a multi-angular X-ray image,

[7] The condition of an adhering calculus is diagnosed visually,

[8] The treatment of a root canal using an image of the apex is supported by means of a root canal meter and the root canal filling is confirmed by means of X-rays,

[9] If a dental pulp is alive or dead is determined and the inflammatory part of a dental pulp is identified and diagnosed for progress by means of X-rays and a laser Doppler blood flowmeter,

[10] The number and the positions of dental roots are confirmed by means of three-dimensional X-ray CT,

[11] A crack and/or a partial loss of a dental root are diagnosed by means of three-dimensional X-ray CT.

However, the above listed items of diagnosis are accompanied by respective problems as described below.

[1] A dental carious (decayed tooth) on the surface of either of two adjacent teeth as detected and diagnosed by means of an X-ray image or visually, irradiating the site with light by means of a lamp accompanies a problem that the displayed image is not clear and hence it is difficult to clearly see the dental carious.

[2] A decalcification of dental enamel (initial dental carious) and a calcification (feasibility of re-calcification) as diagnosed by means of visual observation, palpation using an explorer or fluorometry using a laser-excited fluorometer involve a problem that a re-calcification cannot be confirmed in detail visually and by palpation and, while the result of the fluorometric measurement is displayed by a numeral between 1 and 100, the threshold value is not defined uniformly and hence is not highly reliable.

[3] When an initial carious of dentin and the progress thereof are diagnosed visually, by means of palpation using an explorer or fluorometry using a laser-excited fluorometer, it is not possible to entirely clarify the symptom and, while the result of the fluorometric measurement is displayed by a numeral between 1 and 100, the threshold value is not defined uniformly and hence is not highly reliable.

[4] When an inflammatory part of gingiva and the progress thereof are diagnosed by means of an X-ray image, it is only possible to roughly recognize the progress by seeing the X-ray image if the inflammatory part is in the inside of gingiva.

[5] When the profile of a periodontal pocket is diagnosed visually or by means of a multi-angular X-ray image, it is not possible to entirely clarify the symptom visually and a multi-angular X-ray image involves an invasion upon the patient. When the depth thereof is measured and diagnosed by inserting a pocket probe into the pocket, the patient is stressed to a large extent because the pocket probe is inserted deep into the affected part.

[6] When a carious part of an area hidden in a periodontal pocket is diagnosed by means of a multi-angular X-ray image, such a multi-angular X-ray image involves an invasion upon the patient.

[7] When the condition of an adhering calculus is diagnosed visually, it is not possible to entirely clarify the invisible areas such as the inside of a periodontal pocket and the diagnosis lacks reliability.

[8] When the treatment of a root canal using an image of the apex is supported by means of a root canal meter and the root canal filling is confirmed by means of X-rays, visualization of the measuring operation by means of a root canal meter involves an invasion upon the patient that is required to continue the irradiation of X-rays. The operation of confirming the root canal filling by means of X-rays also involves an invasion on the patient.

[9] For an operation of determining if a dental pulp is alive or dead and identifying and diagnosing the inflammatory part of a dental pulp for progress by means of X-rays and a laser Doppler blood flowmeter, the use of three-dimensional X-ray CT involves an invasion upon the patient and the apparatus for three-dimensional X-ray CT is complex and costly. Additionally, a laser Doppler blood flowmeter is costly to install.

[10] When the number and the positions of dental roots are confirmed by means of three-dimensional X-ray CT, the operation involves an invasion upon the patient and the overall arrangement is complex and costly.

[11] When a crack and/or a partial loss of a dental root are diagnosed by means of three-dimensional X-ray CT, the operation also involves an invasion upon the patient and the overall arrangement is complex and costly.

As an example of application of an OCT apparatus to a living body as in the case of the present invention, a technique of irradiating the object tissue to be observed with low coherence light and acquiring an optical tomography by observing the light scattering rearward relative to the object tissue is known and being used by ophthalmologists to acquire an optical tomography on the detailed structure of the fundus retina. However, with the known technique, the object of observation by means of an OCT apparatus is a soft tissue of a living body that is typically made of water, blood and fat and the outer surface of the affected part is widely open to the air so that the object tissue can be observed with ease. Therefore, such a technique of using an OCT apparatus has been known for long.

However, in the field of dental treatment, the object of observation normally includes hard tissues such as dentin and enamel, soft tissues of the gingiva and periodontal tissues and the space available for the observation is limited in the oral cavity where the rows of teeth exist and the overall profile varies significantly from person to person.

Therefore, for an OCT apparatus for measuring reflected light from a predetermined depth in such hard and soft tissues, the profile of the probe (handpiece) for irradiating low coherence light of a wavelength suitable for the affected part and receiving light reflected from the affected part and the operability of the apparatus are particularly important.

Thus, the present invention provides a dental optical diagnostic apparatus comprising an OCT means that is non-invasive and shows a high resolution in order to dissolve the above-identified problems.

### DISCLOSURE OF THE INVENTION

As a result of intensive research efforts and experiments, the inventors of the present invention invented the following means for dissolving the problems.

(1) A dental optical diagnostic apparatus, characterized by comprising:

a means for generating predetermined low coherence light for irradiating the dental part of an subject;

a means for scanning low coherence light in a selected region of the dental part as signal light; and

an OCT means for acquiring an optical tomography of the scanned region by way of interference of reflected light from a selected depth in the scanned region and reference light showing a slight frequency difference relative to signal light or a modulated phase.

(2) The dental optical diagnostic apparatus according to (1) above, characterized by further comprising:

a means for emitting pointed light to a selected region of the dental part of the subject as viewing guide.

(3) A dental optical diagnostic apparatus, characterized by comprising:

an image pickup means for picking up an image formed by light irradiated onto the dental part of a subject and reflected by the surface of the dental part of the subject;

an image display means for displaying the picked up surface image of the dental part;

a low coherence light generating means for irradiating the dental part;

a means for scanning low coherence light on a selected region of the dental part as signal light; and

an OCT means for acquiring an optical tomography of the scanned region by way of interference of reflected light from a selected depth in the scanned region and reference light showing a slight frequency difference relative to signal light or a modulated phase.

(4) The dental optical diagnostic apparatus according to (3) above, characterized by further comprising:

a surface image display means for displaying the surface image picked up by the image pickup means;

a region indicating means for indicating a predetermined region to be irradiated with low coherence light in the image being displayed by the surface image display means; and

a means for controlling the position for emitting low coherence light to acquire an optical tomography by the OCT means according to the indication by the region indicating means.

(5) The dental optical diagnostic apparatus according to any one of (1) through (4) above, characterized in that the low coherence light generating means includes a light source that covers visible light to ordinary infrared rays and is adapted to switch the wavelength of low coherence light being irradiated onto the dental part of the subject according to the difference of tissue of the site of diagnosis if necessary.

(6) The dental optical diagnostic apparatus according to any one of (1) through (5) above, characterized in that the front end section of the diagnostic probe having a dental handpiece-like profile of the means for acquiring an optical tomography or a surface image and an optical tomography formed by reflected light from the dental part of the subject has a profile adapted to be easily brought into contact with the affected part of the hard tissues and the soft tissues of the dental part in the oral cavity.

(7) The dental optical diagnostic apparatus according to any one of (1) through (6) above, characterized in that

a main body of the dental optical diagnostic apparatus including an image processing section, a display section and an operation section is mounted on a transportable stand or cart and the diagnostic probe having a dental handpiece-like profile is arranged at the front end section of a multi-joint arm extending from a pole standing upright from the main body and adapted to take an attitude that can be controlled vertically and transversally.

(8) The dental optical diagnostic apparatus according to any one of (1) through (6) above, characterized in that

a main body of the dental optical diagnostic apparatus including an image processing section, a display section and an operation section is mounted on a transportable stand or cart and the diagnostic probe having a dental handpiece-like profile and adapted to take an attitude that can be controlled vertically and transversally is arranged at the front end section of an optical fiber or signal line flexibly extending from the main body, while the main body is provided with a holder for removably containing the diagnostic probe.

(9) The dental optical diagnostic apparatus according to any one of (1) through (6) above, characterized in that

the image processing section, the display section and the operation section of the dental optical diagnostic apparatus are incorporated into an dental treatment unit and the diagnostic probe having a dental handpiece-like profile is arranged at the front end section of a multi-joint arm extending from a pole standing upright from the chair unit and adapted to take an attitude that can be controlled vertically and transversally.

(10) The dental optical diagnostic apparatus according to any one of (1) through (6) above, characterized in that

the image processing section, the display section and the operation section of the dental optical diagnostic apparatus are incorporated into an dental treatment unit and the diagnostic probe having a dental handpiece-like profile and adapted to take an attitude that can be controlled vertically and transversally is arranged at the front end section of an optical fiber or signal line flexibly extending from an handpiece containing section of a tray table of the dental treatment unit, while the handpiece containing section of the dental treatment unit is equipped with a holder for removably containing the diagnostic probe.

(11) The dental optical diagnostic apparatus according to any one of (1) through (10) above, characterized in that

the apparatus further comprises an OCT means for acquiring an optical tomography of the region being scanned by low coherence light or an OCT means for acquiring a surface image and an optical tomography of the region being scanned, an image processing section and a wireless image transmission means in the diagnostic probe having a dental handpiece-like profile, and

the diagnostic image is wirelessly transmitted to an image display section arranged at the main body of the dental optical diagnostic apparatus.

(12) The dental optical diagnostic apparatus according to any one of (1) through (11) above, characterized in that

the apparatus further comprises a linearly polarizing means that includes:

a light source for generating linearly polarized low coherence light; and

a linearly polarizing plate arranged on the reflection light path of linearly polarized low coherence light from the dental part, and

that extracts only the non-polarized light dissolving component.

(13) The dental optical diagnostic apparatus according to any one of (1) through (11) above, characterized in that the apparatus further comprises a linearly polarizing means that includes:

a ¼ wave plate arranged on the light path of linearly polarized low coherence light to convert linearly polarized light into circularly polarized light;

a polarization beam splitter for dividing circularly polarized light into linearly polarized lights that are orthogonal relative to each other;

a ¼ wave plate arranged on a reference light path to convert linearly polarized light from the polarization beam splitter into circularly polarized light;

a ¼ wave plate arranged on the reflection light path to convert linearly polarized light into circularly polarized light; and

a linearly polarizing plate arranged in a close proximity of the ¼ wave plate, and

that extracts only the non-polarized light dissolving component.

### BRIEF DESCRIPTION OF THE DRAWINGS

FIG. 1 is a schematic perspective view of a dental optical diagnostic apparatus according to the present invention and comprising an apparatus main body mounted on a cart and a diagnostic probe arranged at the front end of a multi-joint arm, showing the appearance thereof;

FIG. 2 is a schematic perspective view of a dental optical diagnostic apparatus according to the present invention and comprising an apparatus main body mounted on a cart and a diagnostic probe arranged at the front end of an optical fiber or a signal line covered by a tube, showing the appearance thereof;

FIG. 3 is a schematic perspective view of a dental optical diagnostic apparatus according to the present invention and comprising an apparatus main body incorporated into a dental treatment unit and a diagnostic probe arranged at the front end of a multi-joint arm, showing the appearance thereof;

FIG. 4 is a schematic perspective view of a dental optical diagnostic apparatus according to the present invention and comprising an apparatus main body incorporated into a dental treatment unit and a diagnostic probe at the front end of an optical fiber or a signal line covered by a tube, showing the appearance thereof;

FIG. 5 is a schematic block diagram of a dental optical diagnostic apparatus according to the present invention and comprising a diagnostic probe arranged at the front end of an optical fiber, showing the configuration thereof;

FIG. 6 is a schematic block diagram of a dental optical diagnostic apparatus according to the present invention and comprising a diagnostic probe having a surface image pickup means and arranged at the front end of an optical fiber, showing the configuration thereof;

FIG. 7 is a schematic block diagram of a dental optical diagnostic apparatus according to the present invention and comprising an apparatus main body contained in a dental treatment unit, showing the configuration thereof;

FIG. 8 is a schematic block diagram of a dental optical diagnostic apparatus according to the present invention and comprising an apparatus main body having a surface image pickup means and contained in a dental treatment unit, showing the configuration thereof;

FIG. 9 is a schematic block diagram of a dental optical diagnostic apparatus comprising a linearly polarizing plate, where reference symbol 85 denotes the linearly polarizing plate; and

FIG. 10 is a schematic block diagram of a dental optical diagnostic apparatus comprising a linearly polarizing plate, a ¼ wave plate and a polarization beam splitter.

Explanation of Reference Symbols

| 1: | optical diagnostic apparatus | | |
|---|---|---|---|
| 2: | main body | | |
| 3: | operation section | 4: | operation switch |
| 5: | display section | 6: | pole |
| 6′: | probe and lighting pole | 7: | multi-joint arm |
| 8: | pivot section at arm front end | | |
| 9: | diagnostic probe | | |
| 10: | probe pivot section | | |
| 11: | probe front end section | | |
| 12: | observation window | 13: | foot switch |
| 14: | caster | | |
| 15: | tube for optical fiber or signal line | | |
| 16: | tube front end | 17: | tube hanger |
| 18: | diagnostic probe container/holder | | |
| 19: | dental treatment unit | | |
| 20: | incorporated type optical diagnostic appparatus | | |
| 21: | tray table arm | 22: | lighting arm |
| 23: | tray table | 24: | operation section |
| 25: | handpiece holder | 26: | chair |
| 27: | spittoon | | |
| 28: | assistant side handpiece holder | | |
| 29: | diagnostic probe holder | 30: | light source section |
| 31: | signal light | 32: | SLD |
| 33: | mode synchronized laser | 34: | optical fiber |
| 35: | optical fiber coupling section | | |
| 36: | optical fiber coupler | | |
| 37: | reference light scanning section | | |
| 38: | reference light | | |
| 39: | lens | 40: | reflector |
| 41: | oscillator | 42: | movable stage |
| 43: | depth direction scanning | | |
| 44: | signal processing section | | |
| 45: | detector | 46: | amplifier |
| 47: | demodulator | 48: | A/D converter |
| 49: | image processing/scanning control section | | |
| 50: | computer | | |
| 51: | memory device | 52: | LAN connection |
| 53: | printer | 54: | display section |
| 55: | surface image | 56: | optical tomography |
| 57: | observation pattern | 58: | observation data |
| 59: | signal line | 60: | motor |
| 61: | coupling | 62: | nut |
| 63: | ball screw | 64: | sliding rail |
| 65: | surface plate | 66: | mobile stage |
| 67: | lens | 68: | white light source |
| 69: | surface image pickup camera | | |
| 70, 70′: | beam splitter | | |
| 72: | white light path | 72: | signal light path |
| 73: | dental part | 74: | tooth |
| 75: | gingiva | 76: | region specifying marker |
| 77: | rectangular prism | 78: | lens |
| 78′: | focusing lens | | |
| 79: | white light/signal light path | | |
| 80: | detector | 81: | light path |
| 82: | transversal scanning | 83: | guide light source |
| 84: | lens: | 85: | linearly polarizing plate |
| 86: | ¼ wave plate | 87: | polarization beam splitter |

### BEST MODE FOR CARRYING OUT THE INVENTION

It is possible to provide a non-invasive high resolution dental diagnostic apparatus for dental care that is different from X-ray apparatus that are conventional main diagnostic means by using an OCT apparatus as described above.

Now, the present invention will be described in greater detail by referring to the accompanying drawings that illustrate preferred embodiments of the invention.

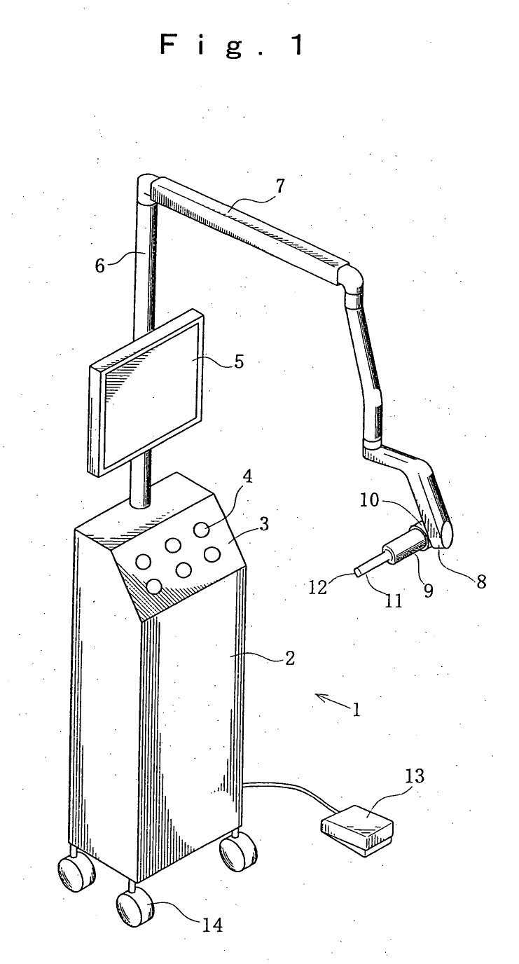

FIG. 1 is a schematic perspective view of a dental optical diagnostic apparatus according to the present invention and comprising an apparatus main body mounted on a cart and a diagnostic probe arranged at the front end of a multi-joint arm, showing the appearance thereof.

FIG. 1 shows an optical diagnostic apparatus 1 having a main body 2, an operation section 3, an operation switch 4, a display section 5, a pole 6, a multi-joint arm 7, a pivot 8 at the front end of the arm 7, a diagnostic probe 9, a pivot 10 of the probe 9, the front end 11 of the probe 9, an observation window 12, a foot switch 13 and a caster 14.

The dental optical diagnostic apparatus 1 comprises a main body 2 containing in the inside thereof various light sources and optical systems thereof, a detector and a demodulator of signal light, an optical image visualizing circuit, an image display circuit and an image processing section (which will be described in greater detail hereinafter) including a signal light scanning region specifying circuit and an operation section 3 (which will also be described in greater detail hereinafter) having an operation switch 4 on an upper panel surface thereof.

The apparatus 1 also comprises a pole 6 standing up from the operation section 3, a display section 5 fitted to the pole 6 at the height of the viewer's eyes and a multi-joint arm 7 extending transversally from the front end of the pole 6.

The multi-joint arm 7 has a pivot 8 at the front end thereof, to which a dental diagnostic probe 9 is fitted. The probe 9 by turn has a pivot 10 at the base end and an observation window 12 at the front end 11 and contains in the inside the optical system (which will be described in greater detail hereinafter) of the OCT apparatus for picking up a surface image and acquiring an optical tomography.

The observation window 12 at the front end 11 of the diagnostic probe 9 does not shake and can be brought into contact with the dental part of the subject at a predetermined site (not shown) by attitude control, using the multi-joint arm 7 and the pivot 10 of the probe. Thus, it is possible to obtain a wide surface image and an optical tomography of a small area.

The light source and the optical system for picking up a surface image can be omitted when it is not necessary to pick up a surface image.

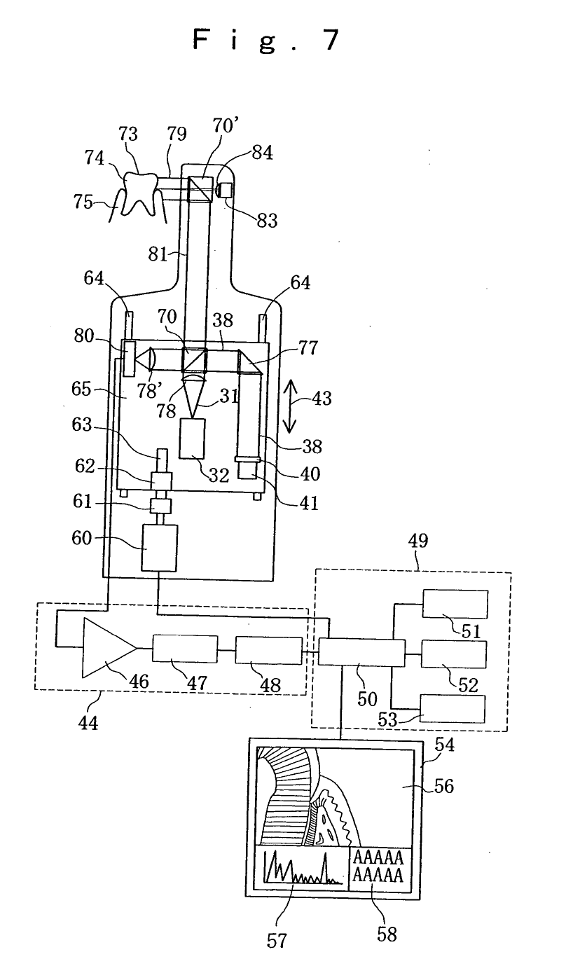

When the operator illuminates the target site of the dental part with a guide light spot (a beam of visible light) in order to bring the diagnostic probe into contact with the dental part at the site, an irradiation mechanism including a guide light source (83: preferably red or green light), a lens (84) for converging the beam and a probe observation window 12 is required (see FIG. 7).

The probe can be operated by means of the foot switch 13 to free the operator's hands. The main body 2 can be moved to a position most suitable for diagnosing activities by means of casters 14. A touch panel may be used for the display section 5 to omit the operation section 3 (not shown).

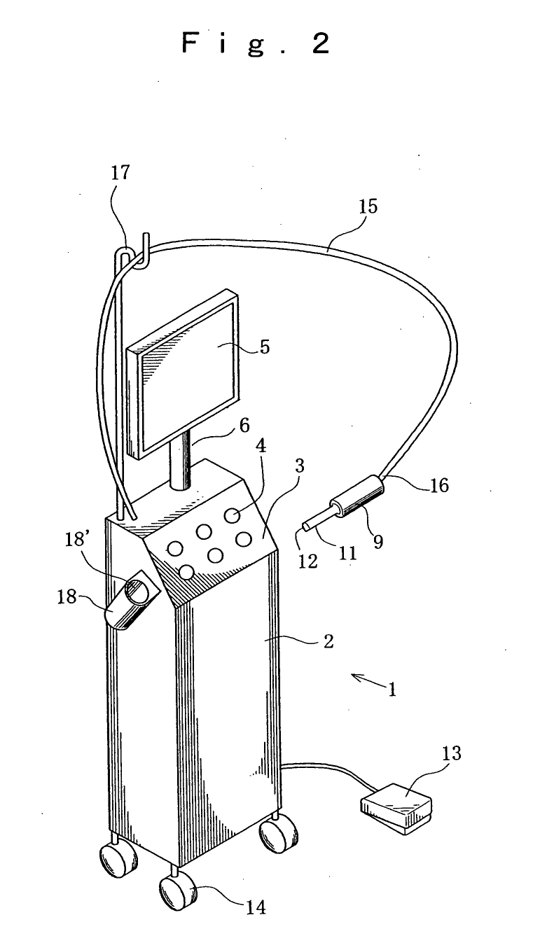

FIG. 2 is a schematic perspective view of a dental optical diagnostic apparatus according to the present invention and comprising an apparatus main body mounted on a cart and a diagnostic probe arranged at the front end of an optical fiber or a signal line covered by a tube, showing the appearance thereof.

In FIG. 2, there are shown a tube 15 for an optical fiber or a signal line, the front end 16 of the tube 15, a tube hanger 17 and a diagnostic probe container/holder 18.

The dental optical diagnostic apparatus 1 of FIG. 2 comprises a main body 2 containing in the inside thereof various light sources and optical systems thereof, a detector and a demodulator of signal light, an optical image visualizing circuit, an image display circuit and an image processing section (which will be described in greater detail hereinafter) including a signal light scanning region specifying circuit and an operation section 3 (which will also be described in greater detail hereinafter) having an operation switch 4 on an upper panel surface thereof.

The apparatus 1 also comprises a pole 6 standing up from the operation section 3, a display section 5 fitted to the pole 6 at the height of the viewer's eyes and a tube 15 covering a flexible optical fiber or a signal line extending from an upper part of the operation section 3 of the main body 2.

A dental diagnostic probe 9 is fitted to the front end 16 of the tube 15. The probe 9 by turn has an observation window 12 at the front end 11 and contains in the inside the optical system (which will be described in greater detail hereinafter) of the OCT apparatus for picking up a surface image and acquiring an optical tomography.

The observation window 12 at the front end 11 of the diagnostic probe 9 can be brought into contact with the dental part of the subject at a predetermined site (not shown) by attitude control freely by the operator holding the diagnostic probe 9, utilizing the flexibility of the optical fiber or the signal line and the tube 15 covering it. Thus, it is possible to obtain a wide surface image and an optical tomography of a small area.

The light source and the optical system for picking up a surface image can be omitted when it is not necessary to pick up a surface image.

When the operator illuminates the target site of the dental part with a guide light spot (a beam of visible light) in order to bring the diagnostic probe into contact with the dental part at the site, an irradiation mechanism including a guide light source (83: preferably red or green light), a lens (84) for converging the beam and a probe observation window 12 is required (see FIG. 7).

The tube hanger 17 holds the rising part of the tube 15 high so that the diagnostic probe 9 may be operated with ease.

When the diagnostic probe 9 is not in use, it is contained in the diagnostic probe container/holder 18. In FIG. 2, reference symbol 18′ denotes a buffer for preventing the diagnostic probe from being subjected to impact when it is contained in the container/holder 18. The probe can be operated by means of the foot switch 13 to free the operator's hands. The main body 2 can be moved to a position most suitable for diagnosing activities by means of casters 14.

A touch panel may be used for the display section 5 to omit the operation section 3.

This apparatus has a simplified structure because it does not use a multi-joint arm 7.

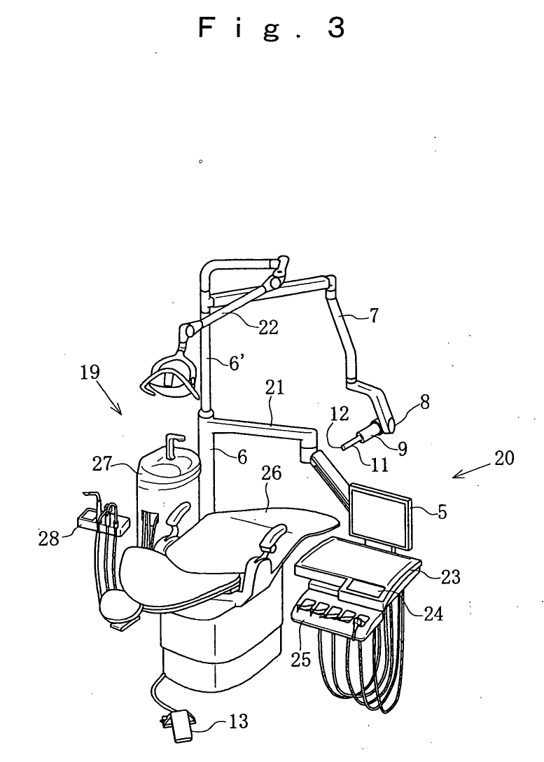

FIG. 3 is a schematic perspective view of a dental optical diagnostic apparatus according to the present invention and comprising an apparatus main body incorporated into a dental treatment unit and a diagnostic probe arranged at the front end of a multi-joint arm, showing the appearance thereof.

FIG. 3 shows a probe and lighting pole 6′, a dental treatment unit 19, an incorporated type optical diagnostic apparatus 20, a tray table arm 21, a lighting arm 22, a tray table 23, an operation section 24, a handpiece holder 25, a chair 26, a spittoon 27 and an assistant side handpiece holder 28.

Of the incorporated type optical diagnostic apparatus 20, the various light sources and the optical systems thereof, the detector and the demodulator of signal light, the optical image visualizing circuit, the image display circuit and the image processing section (which will be described in greater detail hereinafter) including a signal light scanning region specifying circuit and the display section are contained in the chair unit.

The image processing section (not shown) is arranged under the tray table 23 and the display section is standing behind the tray table 23, while the operation section 24 is arranged in front of the tray table 23.

A pole 6 is standing near a lateral side of the chair 26 and the tray table arm 21 and the probe and lighting pole 6′ extend from the pole 6. Then, the lighting arm 22 and a multi-joint arm 7 extend from the probe and lighting pole 6′. The multi-joint arm 7 has a pivot 8 at the front end thereof, to which a dental diagnostic probe 9 is fitted. The probe 9 by turn has a pivot 10 at the base end and an observation window 12 at the front end 11 and contains in the inside the optical system of the OCT apparatus for picking up a surface image and acquiring an optical tomography.

The observation window 12 at the front end 11 of the diagnostic probe 9 does not shake and can be brought into contact with the dental part of the subject at a predetermined site (not shown) by attitude control, using the multi-joint arm 7 and the pivot 10 of the probe. Thus, it is possible to obtain a wide surface image and an optical tomography of a small area.

The light source and the optical system for picking up a surface image can be omitted when it is not necessary to pick up a surface image.

When the operator illuminates the target site of the dental part with a guide light spot (a beam of visible light) in order to bring the diagnostic probe into contact with the dental part at the site, an irradiation mechanism including a guide light source (83: preferably red or green light), a lens (84) for converging the beam of the guide light and a probe observation window 12 is required (see FIG. 7).

Since the optical diagnostic apparatus is incorporated into a dental treatment unit 19, such a dental treatment unit 19 is useful because it has a functional feature of dental diagnosis using OCT.

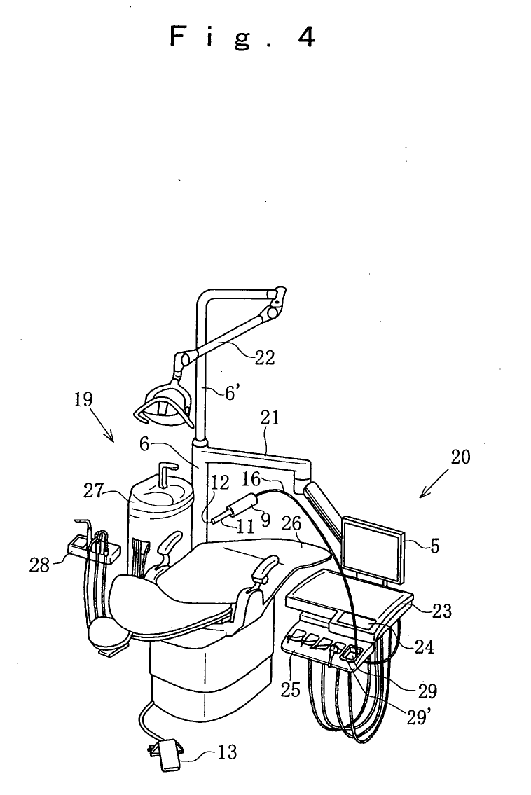

FIG. 4 is a schematic perspective view of a dental optical diagnostic apparatus according to the present invention and comprising an apparatus main body incorporated into a dental treatment unit and a diagnostic probe at the front end of an optical fiber or a signal line covered by a tube, showing the appearance thereof.

In FIG. 4, reference symbol 29 denotes a diagnostic probe holder and 29′ denotes a buffer for preventing the diagnostic probe from being subjected to impact when it is held by the holder.

Of the optical diagnostic apparatus 20, the various light sources and the optical systems thereof, the detector and the demodulator of signal light, the optical image visualizing circuit, the image display circuit and the image processing section (which will be described in greater detail hereinafter) including a signal light scanning region specifying circuit and the display section are contained in the chair unit.

The image processing section (not shown) is arranged under the tray table 23 and the display section is standing behind the tray table 23, while the operation section 24 is arranged in front of the tray table 23.

A pole 6 is standing near a lateral side of the chair 26 and the tray table arm 21, a lighting pole 6′ and a lighting arm 22 extend from the pole 6.

The diagnostic probe 9 of this diagnostic apparatus has a front end section 11 equipped with an observation window 12 at the front end 16 of the tube 15 extending from the holder 29 of the diagnostic probe and contains in the inside the optical system of the OCT apparatus for picking up a surface image and acquiring an optical tomography.

The light source and the optical system for picking up a surface image can be omitted when it is not necessary to pick up a surface image.

When the operator illuminates the target site of the dental part with a guide light spot (a beam of visible light) in order to bring the diagnostic probe into contact with the dental part at the site, an irradiation mechanism including a guide light source (83: preferably red or green light), a lens (84) for converging the beam and a probe observation window 12 is required (see FIG. 7).

The observation window 12 at the front end 11 of the diagnostic probe 9 can be brought into contact with the dental part of the subject at a predetermined site (not shown) by attitude control freely by the operator holding the diagnostic probe 9, using the flexibility of the optical fiber or the signal line and the tube 15 covering it. Thus, it is possible to obtain a wide surface image and an optical tomography of a small area.

When the diagnostic probe 9 is not in use, it is contained in the diagnostic probe holder 29.

This apparatus has a simplified structure because it does not use a multi-joint arm 7.

Since the optical diagnostic apparatus 20 is incorporated into a dental treatment unit 19, such a dental treatment unit 19 is useful because it has a functional feature of dental diagnosis using OCT.

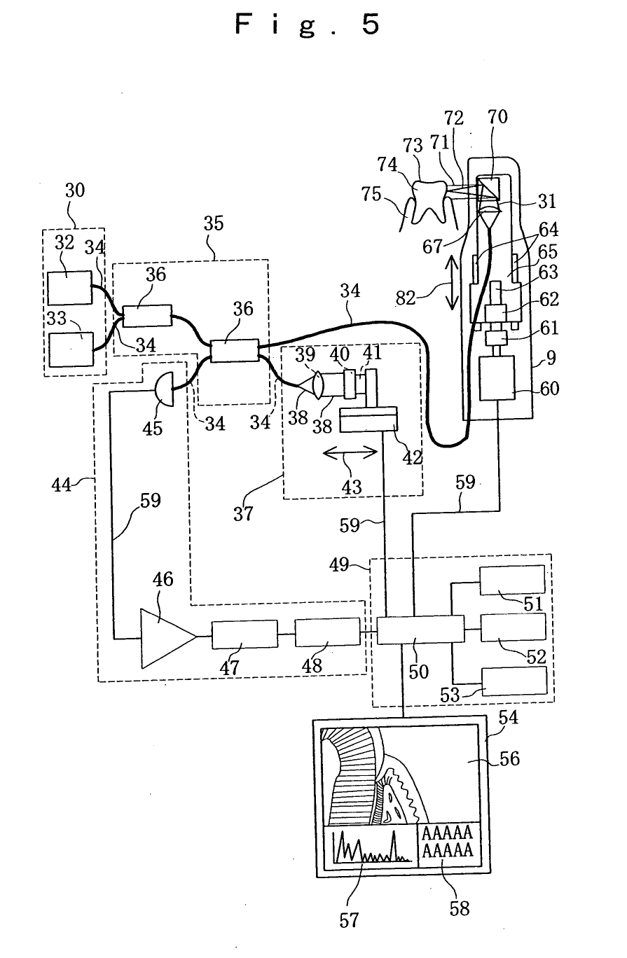

FIG. 5 is a schematic block diagram of a dental optical diagnostic apparatus according to the present invention and comprising a diagnostic probe arranged at the front end of an optical fiber, showing the configuration thereof.

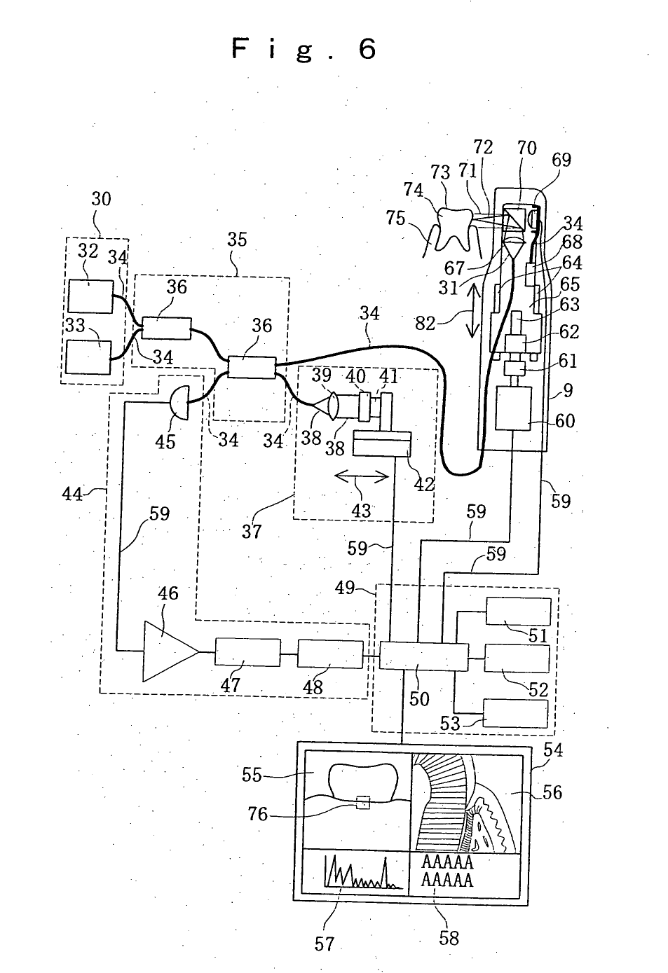

FIG. 6 is a schematic block diagram of a dental optical diagnostic apparatus according to the present invention and comprising a diagnostic probe having a surface image pickup means and arranged at the front end of an optical fiber, showing the configuration thereof.

Summarily, the dental optical diagnostic apparatus of FIG. 6 acquires a surface image by means of a camera. It also acquires a one-dimensional reflection light profile by scanning the reference light position of the OCT apparatus and then a two-dimensional optical tomography by scanning a light beam in a transversal direction. The acquired two images are displayed to assist the diagnosing operation of the dentist.

In FIGS. 5 and 6, there are shown a light source section 30, signal light 31, an SLD (super luminescent diode) 32, a mode synchronized laser (forsterite) 33, an optical fiber 34, an optical fiber coupling section 35, an optical fiber coupler 36, a reference light scanning section 37, reference light 38, a lens 39, a reflector 40, an oscillator 41, a movable stage 42, depth direction scanning 43, a signal processing section 44, a detector 45, an amplifier 46, a demodulator 47, an A/D converter 48, an image processing/scanning control section 49, a computer 50, a memory device 51, a LAN connection 52, a printer 53, a display section 54, a surface image 55, an optical tomography 56, an observation pattern 57, observation data 58, a signal line 59, a motor 60, a coupling 61, a nut 62, a ball screw 63, a sliding rail 64, a surface plate 65, a mobile stage 66 ( [symbol] ), a lens 67, a white light source 68, a surface image pickup camera 69, a beam splitter 70, a white light path 71, a signal light path 72, a dental part 73, a tooth 74, a gingiva 75 and a region specifying marker 76.

As shown in FIGS. 5 and 6, the white light source 68 arranged in the inside of the optical diagnostic probe 9 emits white light, transmits it by way of the optical fiber 34 and irradiates it onto the dental part 73 of the subject from the vicinity of the front side of the surface image pickup camera 69 by way of the white light path 71 so that a wide surface image is obtained by means of the surface image pickup camera 69. The image is stored in the memory device 51 of the computer 50 and also displayed on the display section for the surface image 55 of the monitor by the computer 50 for observation.

The monitor also displays a region specifying marker 76 for specifying a display region in the optical tomography 56 at a side of the surface image 55.

The light source of low coherence light to be used for acquiring an optical tomography 56 is adapted to cover visible light to ordinary infrared rays by switching the use of the SLD 32, the mode synchronized laser: Cr⁻⁴⁺:Mg₂SiO₄ (forsterite) 33 and so on.

When the wavelength of light is changed remarkably, the current optical fiber may be replaced, if necessary, by an optical fiber that corresponds to the wavelength to be used or two or more than two optical systems having respective optical fibers may be provided in parallel and selectively used (not shown).

Low coherence light (signal light 31) proceeds by way of the optical fiber 34 and the optical fiber coupler 36 of the optical fiber coupling section 35 and gets into the lens 67 in the inside of the optical diagnostic probe 9 by way of the extended part of the optical fiber 34. Then, low coherence light is converged by the lens 67 and bent by 90° by the beam splitter 70 to move the irradiation of the optical diagnostic probe 9 to the position of the region specifying marker 76 of the optical tomography 56 at a side of the surface image 55 being displayed on the monitor of the display section 54. In this way, the signal light path 72 is converged to the predetermined diagnostic region of the dental part 73.

Low coherence light reflected from the selected depth of the dental part proceeds the above-described route reversely to get to the optical fiber coupler 36 and then to the detector 45 of the signal processing section 44 by way of the optical fiber 34.

On the other hand, reference light is modulated for the phase by the reflector 40 and the oscillator 41. The depth for acquiring a tomographic image can be selected by moving the movable stage 42.

Signal light 31 and reference light 38 are synthetically combined by the optical fiber coupler 36 so as to interfere with each other and the light interference signal is displayed on the monitor as an optical tomography 56 of the predetermined region by the amplifier 46, the demodulator 47, the A/D converter 48 and the computer 50.

The observation pattern 57 in a lower part of the monitor is a profile of reflected light in the direction of the optical axis obtained by plotting the depth and the dimension of the light interference signal detected on the light path respectively along the horizontal axis and the vertical axis. The optical tomography 56 visualizes the two-dimensional optical image by the transversal scanning of incident light.

Additionally, the observed data 58 are displayed on the monitor and, if they are stored with the images in the memory device 51, it is possible to reproduce the record of the diagnostic whenever necessary.

The light source and the optical system as shown in FIG. 5 can be omitted when it is not necessary to pick up a surface image.

When the operator illuminates the target site of the dental part with a guide light spot (a beam of visible light) in order to bring the diagnostic probe 9 into contact with the dental part at the site, an irradiation mechanism including a guide light source (83: preferably red or green light), a lens 67 (shared) for converging the beam and a probe observation window 12 is required.

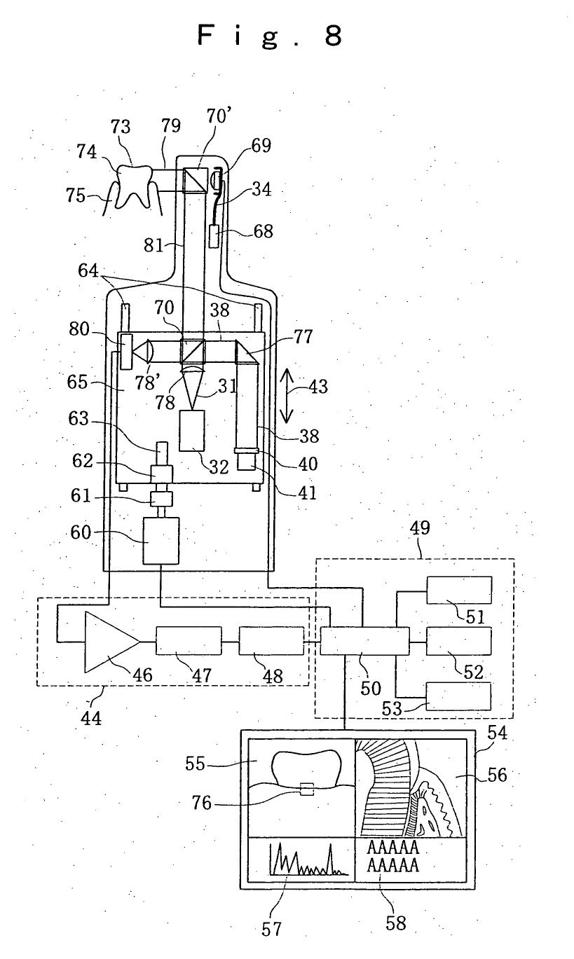

FIG. 7 is a schematic block diagram of a dental optical diagnostic apparatus according to the present invention and comprising an apparatus main body contained in a dental treatment unit, showing the configuration thereof. FIG. 8 is a schematic block diagram of a dental optical diagnostic apparatus according to the present invention and comprising an apparatus main body having a surface image pickup means and contained in a dental treatment unit, showing the configuration thereof.

The dental optical diagnostic apparatus as shown in FIGS. 7 and 8 are referred to as of the bulk type. Such an apparatus is adapted to irradiate a beam of parallel light onto the dental part of a subject, detect signal light on a pixel by pixel basis by means of a detector such as a CCD or a CMOS where pixels are arranged two-dimensionally and process the detected pieces of information on the respective pixels in parallel to acquire a two-dimensional cross-sectional view on a real time basis. Thus, such an apparatus is effective to reduce the time of diagnosis.

In FIG. 8, there are shown a rectangular prism 77, a lens 78, a white light/signal light path 79, a detector 80 and a light path 81.

As shown in FIG. 8, the white light source 68 (e.g., LED) arranged in the inside of the optical diagnostic probe 9 emits white light and irradiates it onto the dental part 73 of the subject from the vicinity of the front side of the surface image pickup camera 69 by way of a beam splitter 70′ and a white light/signal light path 79 so that a wide surface image is obtained by means of the surface image pickup camera 69.

The image is stored in the memory device 51 of the computer 50 and also displayed on the display section for the surface image 55 of the monitor by the computer 50 for observation.

The monitor also displays a region specifying marker 76 for specifying a display region in the optical tomography 56 at a side of the surface image 55.

The light source of low coherence light to be used for acquiring an optical tomography 56 is adapted to cover visible light to ordinary infrared rays by switching the use of the SLD 32, the mode synchronized laser: Cr⁻⁴⁺:Mg₂SiO₄ (forsterite) 33 (not shown) and so on. Low coherence light (signal light 31) is made to enter the beam splitter 70 as parallel light having a predetermined cross sectional area by means of the lens 78.

Signal light 31 gets the beam splitter 70′ by way of the light path 81 and is then bent by 90° to irradiate the predetermined diagnostic region of the dental part 73 by way of the white light/signal light path 79 and become reflected from the selected depth.

It is possible to omit scanning in the horizontal and vertical directions since the region of irradiation is not a point but two-dimensional.

On the other hand, the light path of reference light 38 is bent by 90° by the beam splitter 70 and then further 90° by the rectangular prism 77 and modulated for phase by the reflector 40 and the oscillator 41 before it is reflected to return to the beam splitter 70 by way of the rectangular prism 77.

Reflected light reversely follows the above light path to get to the beam splitter 70, where it is mixed and interfere with reference light, and then sent out to the detector 80 of the signal processing section 44 by way of the focusing lens 78′.

Signal light 31 and reference light 38 are synthetically combined by the beam splitter 70 so as to interfere with each other and the light interference signal is displayed as an optical tomography 56 of the predetermined region by the amplifier 46, the demodulator 47, the A/D converter 48 and the computer 50.

Since the operator can acquire an optical tomography 56 of the dental part 73 in the direction of a selected depth on a real time basis, while observing the surface image 55 obtained by the surface image pickup camera 69, so that the dentist can observe the dental part three-dimensionally and dynamically diagnosis the dental part.

The observation pattern 57 in a lower part of the monitor is a profile of reflected light in the direction of the optical axis obtained by plotting the depth and the dimension of the light interference signal detected on the light path respectively along the horizontal axis and the vertical axis. Thus it is possible to display an image of a wide area in a short period of time.

Additionally, the observed data 58 are displayed on the monitor and, if they are stored with the images, it is possible to reproduce the record of the diagnostic whenever necessary.

The light source and the optical system as shown in FIG. 7 can be omitted when it is not necessary to pick up a surface image.

When the operator illuminates the target site of the dental part with a guide light spot (a beam of visible light) in order to bring the diagnostic probe into contact with the dental part at the site, an irradiation mechanism including a guide light source (83: preferably red or green light), a lens 84 for converging the beam and a probe observation window 12 as shown in FIG. 7 is required.

Although the principle is same as that of the dental optical diagnostic apparatus illustrated in the block diagrams of FIGS. 5 through 7, the optical diagnostic probe may be realized as a pistol type probe that contains the components including the detector 80 and the downstream ones including the amplifier 46, the demodulator 47, the A/D converter 48, the computer 50 and a wireless transmitter in the grip part thereof as shown in FIG. 8. Then, the video information prepared by the computer 50 may be transmitted by the wireless transmitter and the image of the transmitted video information may be displayed on the display section of a receiver having an antenna arranged at an appropriate nearby position (not shown).

With the above-described arrangement, it is possible to provide a further downsized and simplified dental optical diagnostic apparatus.

Now, a dental optical diagnostic apparatus having a linear polarization means will be described below.

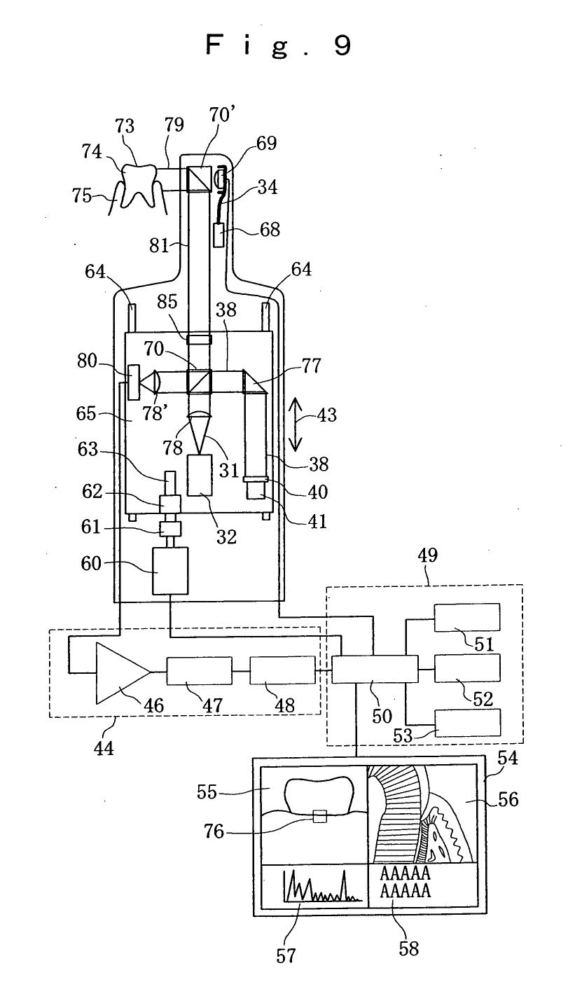

FIG. 9 is a schematic block diagram of a dental optical diagnostic apparatus comprising a linearly polarizing plate, where reference symbol 85 denotes the linearly polarizing plate.

The linearly polarizing plate 85 is arranged on the multiplex reflection light path 81 between the beam splitter 70 and the dental part 73 so that only the non-polarization dissolving component can be extracted and detected from the dental part 73 if low coherence light is linearly polarized.

Secondary reflection light from a unstably profiled very small surface of the dental part 73 becomes to show no clear polarization and hence dissolve the polarization, if any, but primary reflection light from incident light reflects polarization.

Therefore, it is possible to obtain an optical tomography 56 of the dental part 73 that shows a low background noise level, a high resolution and an excellent signal to noise ratio by arranging a linearly polarizing plate 85 on the multiplex reflection light path 81 between the beam splitter 70 and the dental part 73 and removing the reflected light deviated from the linearly polarized surface of incident light.

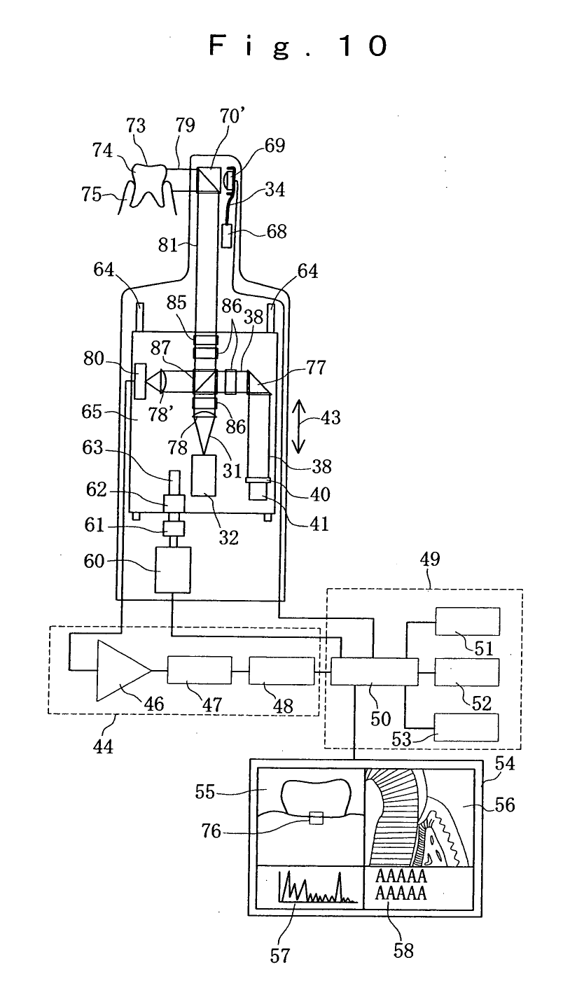

FIG. 10 is a schematic block diagram of a dental optical diagnostic apparatus comprising a linearly polarizing plate, a ¼ wave plate and a polarization beam splitter.

In FIG. 10, reference symbol 86 denotes a ¼ wave plate and reference symbol 87 denotes a polarization beam splitter.

Thus, the arrangement of FIG. 10 is realized by replacing the beam splitter 70 of FIG. 9 with the polarization beam splitter 87 and three ¼ wave plates 86 are arranged respectively between the polarization beam splitter 87 and the linearly polarizing plate 85, between the polarization beam splitter 87 and the rectangular prism 77 and between the polarization beam splitter 87 and the lens 78.

On the light path of low coherence light, linearly polarized light output from the SLD 32 of the light emitting element is transmitted through the ¼ wave plate 86 to turn into circularly polarized light, which is then divided into two linearly polarized lights that are polarized in respective directions orthogonal relative to each other by means of the polarization beam splitter 87.

Of these, the linearly polarized light component that is guided by the reference light path is transmitted through the ¼ wave plate 86 and the rectangular prism 77, reflected by the reference mirror (the reflector 40 and the oscillator 41) and modulated for phase before it follows the route reversely so as to be transmitted through the ¼ wave plate 86 and the polarization beam splitter 87 once again and guided to the detector 80.

On the other hand, the linearly polarized light component that is guided by the reflection light path is transmitted through the ¼ wave plate 86 and the linearly polarizing plate 85 and irradiated onto the dental part 73.

Multiplex reflection light from the dental part 73 is turned into linearly polarized light by the combination of appropriate angles of the linearly polarizing plate 85 and the 4/1 wave plate 86 and guided to the detector 80 by way of the polarization beam splitter 87.

Thus, as a result, it is possible to minimize the optical loss on the way and the multiplex reflection light and reference light can be made to interfere with each other and detected efficiently as two linearly polarized light that are parallel with each other.

The above-described embodiments of the present invention can be modified in various different ways without departing from the spirit and scope of the invention.

### INDUSTRIAL APPLICABILITY

Thus, the present invention provides the following remarkable advantages.

1. According to claim 1, there is provided a dental optical diagnostic apparatus comprising:

a means for generating predetermined low coherence light for irradiating the dental part of a subject;

a means for scanning low coherence light in a selected region of the dental part as signal light; and

an OCT means for acquiring an optical tomography of the scanned region by way of interference of reflected light from a selected depth in the scanned region and reference light showing a slight frequency difference relative to signal light or a modulated phase.

Thus, it is possible to provide a diagnostic apparatus that is non-invasive and shows a high resolution when diagnosing a dental part including hard tissues of dentin and enamel, soft tissues of gingiva and periodontium where hard tissues and soft tissues are intermingled in a complex manner unlike conventional various diagnostic apparatus mainly based on the use of X-rays.

2. According to claim 2,

the dental optical diagnostic apparatus according to claim 1 further comprises:

a means for emitting pointed light to a selected region of the dental part of the subject as viewing guide.

Thus, the operator can bring the diagnostic probe having a dental handpiece-like profile into contact with the dental part of a subject with ease.

3. According to claims 3 and 4,

it is possible to display both a surface image produced as illumination light emitted onto the dental part of a subject is reflected by the surface of the dental part and an optical tomography in a specified region of the displayed surface image. Thus, a dentist can acquire an optical tomography of the dental part at a selected depth, while observing a surface image and diagnose the tissues of the dental part without difficulty.

4 According to claim 4,

the dental optical diagnostic apparatus according to claim 4 further comprises:

a region indicating means for indicating a predetermined region to be irradiated with low coherence light in the image being displayed by the surface image display means; and

a means for controlling the position for emitting low coherence light to acquire an optical tomography by the OCT means according to the indication by the region indicating means.

Thus, a dentist can acquire a desired optical tomography and accurately diagnose the tissues of the dental part.

5. According to claim 5,

the wavelength of low coherence light being irradiated onto the dental part of a subject is switched according to the difference of tissue of the site of diagnosis if necessary.

Thus, a dentist can accurately diagnose the dental part of a subject having complex tissues by changing the wavelength of illumination light according to the site of diagnoses.

6. According to claim 6,

the front end section of the diagnostic probe having a dental handpiece-like profile of the means for acquiring an optical tomography or a surface image and an optical tomography formed by reflected light from the dental part of the subject has a profile adapted to be easily brought into contact with the affected part of the hard tissues and the soft tissues of the dental part in the oral cavity.

Thus, a dentist can diagnose the dental part in the oral cavity of a subject with ease although the oral cavity has only a small space available to the dentist and can vary significantly from person to person.

7. According to claim 7,

a main body of the dental optical diagnostic apparatus including an image processing section, a display section and an operation section is mounted on a transportable stand or cart and the diagnostic probe having a dental handpiece-like profile is arranged at the front end section of a multi-joint arm extending from a pole standing upright from the main body and adapted to take an attitude that can be controlled vertically and transversally.

Thus, it is possible to move the apparatus to an optical position near the patient with ease and the observation window at the front end section of the diagnostic probe can be brought into contact with a predetermined position of the dental part by controlling the attitude of the observation window by means of the pivot at the front end of the multi-joint arm and that of the probe. Additionally, since the probe does not shake, it is possible to obtain a stable optical tomography of a small area or a wide surface image and an optical tomography of a small area.

8. According to claim 8,

a main body of the dental optical diagnostic apparatus including an image processing section, a display section and an operation section is mounted on a transportable stand or cart and the diagnostic probe having a dental handpiece-like profile and adapted to take an attitude that can be controlled vertically and transversally is arranged at the front end section of an optical fiber or signal line flexibly extending from the main body, while the main body is provided with a holder for removably containing the diagnostic probe.

Thus, it is possible to move the apparatus to an optimal position near the patient with ease and the operator can hold the diagnostic probe and freely control the attitude of the probe so as to bring the observation window at the front end of the diagnostic probe into contact with the dental part of the subject at a predetermined position. Therefore, it is possible to obtain a stable optical tomography of a small area or a wide surface image and an optical tomography of a small area. Additionally, the apparatus can be simplified because it does not require a multi-joint arm.

9. According to claim 9,

the image processing section, the display section and the operation section of the dental optical diagnostic apparatus are incorporated into an dental treatment unit and the diagnostic probe having a dental handpiece-like profile is arranged at the front end section of a multi-joint arm extending from a pole standing upright from the chair unit and adapted to take an attitude that can be controlled vertically and transversally.

Thus, the apparatus is useful as dental treatment unit having a functional feature of diagnosing the dental part of a subject by means of OCT and the observation window at the front end of the diagnostic probe can be brought into the dental part of the subject at a predetermined position by controlling the attitude thereof by means of the multi-joint arm and the diagnostic probe. Additionally, since the diagnostic probe does not shake, it is possible to obtain a stable optical tomography of a small area or a wide surface image and an optical tomography of a small area.

10. According to claim 10,

the image processing section, the display section and the operation section of the dental optical diagnostic apparatus are incorporated into an dental treatment unit and the diagnostic probe having a dental handpiece-like profile and adapted to take an attitude that can be controlled vertically and transversally is arranged at the front end section of an optical fiber or signal line flexibly extending from an handpiece containing section of a tray table of the dental treatment unit, while the handpiece containing section of the dental treatment unit is equipped with a holder for removably containing the diagnostic probe.

Thus, the apparatus is useful as dental treatment unit having a functional feature of diagnosing the dental part of a subject by means of OCT and the operation can bring the observation window at the front end of the diagnostic probe into contact with the dental part of the subject at a predetermined position by holding the diagnostic probe and controlling the attitude thereof so that it is possible to obtain an optical tomography of a small area or a wide surface image and an optical tomography of a small area. Additionally, the apparatus can be simplified because it does not require a multi-joint arm.

11. According to claim 11,

the dental optical diagnostic apparatus according to one of claims 1 through 10 further comprises:

an OCT means for acquiring an optical tomography of the region being scanned by low coherence light or an OCT means for acquiring a surface image and an optical tomography of the region being scanned, an image processing section and a wireless image transmission means in the diagnostic probe having a dental handpiece-like profile and

the diagnostic image is wirelessly transmitted to a display section arranged at the main body of the dental optical diagnostic apparatus.

Thus, the optical diagnostic probe may be realized as of a pistol type probe that contains components including a detector and the downstream ones including an amplifier, a demodulator, an A/D converter, a computer and a wireless transmitter in the grip part thereof. Then, the video information prepared by the computer may be transmitted by the wireless transmitter and the image of the transmitted video information may be displayed on the display section of a receiver having an antenna arranged at an appropriate nearby position. With the above-described arrangement, it is possible to provide a further downsized and simplified dental optical diagnostic apparatus.

12. According to claim 12,

the dental optical diagnostic apparatus according to one of claims 1 through 11 further comprises:

a linearly polarizing means that includes:

a light source for generating linearly polarized low coherence light; and

a linearly polarizing plate arranged on the reflection light path of linearly polarized low coherence light from the dental part, and

that extracts only the non-polarized light dissolving component.

Accordingly, the reflected light having polarized surface deviated from the linearly polarized surface of incident light can be removed. Thus, it is possible to obtain an optical tomography showing a high resolution and an excellent signal to noise ratio.

13. According to claim 13,

a dental optical diagnostic apparatus according to one of claims 1 through 11 further comprises:

a linearly polarizing means that includes:

a ¼ wave plate arranged on the light path of linearly polarized low coherence light to convert linearly polarized low coherence light into circularly polarized light;

a polarization beam splitter for dividing circularly polarized light into two linearly polarized lights that are orthogonal relative to each other;

a ¼ wave plate arranged on a reference light path to convert linearly polarized light from the polarization beam splitter into circularly polarized light;

a ¼ wave plate arranged on the reflection light path to convert linearly polarized light from the polarization beam splitter into circularly polarized light; and

a linearly polarizing plate arranged in a close proximity of the ¼ wave plate.

Thus, it is possible to minimize the optical loss on the way and multiplex reflection light and reference light can be made to interfere with each other and detected efficiently as two linearly polarized light that are parallel with each other. Then, it is possible to obtain an optical tomography showing a high resolution and an excellent signal to noise ratio.

1. A dental optical diagnostic apparatus, characterized by comprising:
means for generating predetermined low coherence light for irradiating the dental part of a subject;
means for scanning low coherence light in a selected region of the dental part as signal light; and
OCT means for acquiring an optical tomography of the scanned region by way of interference of reflected light from a selected depth in the scanned region and reference light showing a slight frequency difference relative to signal light or a modulated phase.

2. The dental optical diagnostic apparatus according to claim 1, characterized by further comprising:
means for emitting pointed light to a selected region of the dental part of the subject as viewing guide.

3. A dental optical diagnostic apparatus, characterized by comprising:
image pickup means for picking up an image formed by light irradiated onto the dental part of a subject and reflected by the surface of the dental part of the subject;
image display means for displaying the picked up surface image of the dental part;
low coherence light generating means for irradiating the dental part;
means for scanning low coherence light on a selected region of the dental part as signal light; and
OCT means for acquiring an optical tomography of the scanned region by way of interference of reflected light from a selected depth in the scanned region and reference light showing a slight frequency difference relative to signal light or a modulated phase.

4. The dental optical diagnostic apparatus according to claim 3, characterized by further comprising:
surface image display means for displaying the surface image picked up by the image pickup means;
region indicating means for indicating a predetermined region to be irradiated with low coherence light in the image being displayed by the surface image display means; and
means for controlling the position for emitting low coherence light to acquire an optical tomography by the OCT means according to the indication by the region indicating means.

5. The dental optical diagnostic apparatus according to claim 1, characterized in that
the low coherence light generating means includes a light source that covers visible light to ordinary infrared rays and is adapted to switch the wavelength of low coherence light being irradiated onto the dental part of the subject according to the difference of tissue of the site of diagnosis if necessary.

6. The dental optical diagnostic apparatus according to claim 1, characterized in that
the front end section of the diagnostic probe having a dental handpiece-like profile of the means for acquiring an optical tomography or a surface image and an optical tomography formed by reflected light from the dental part of the subject has a profile adapted to be easily brought into contact with the affected part of the hard tissues and the soft tissues of the dental part in the oral cavity.

7. The dental optical diagnostic apparatus according to claim 1, characterized in that
a main body of the dental optical diagnostic apparatus including an image processing section, a display section and an operation section is mounted on a transportable stand or cart and the diagnostic probe having a dental handpiece-like profile is arranged at the front end section of a multi-joint arm extending from a pole standing upright from the main body and adapted to take an attitude that can be controlled vertically and transversally.

8. The dental optical diagnostic apparatus according to claim 1, characterized in that
a main body of the dental optical diagnostic apparatus including an image processing section, a display section and an operation section is mounted on a transportable stand or cart and the diagnostic probe having a dental handpiece-like profile and adapted to take an attitude that can be controlled vertically and transversally is arranged at the front end section of an optical fiber or signal line flexibly extending from the main body, while the main body is provided with a holder for removably containing the diagnostic probe.

9. The dental optical diagnostic apparatus according to claim 1, characterized in that
the image processing section, the display section and the operation section of the dental optical diagnostic apparatus are incorporated into a dental treatment unit and the diagnostic probe having a dental handpiece-like profile is arranged at the front end section of a multi-joint arm extending from a pole standing upright from the chair unit and adapted to take an attitude that can be controlled vertically and transversally.

10. The dental optical diagnostic apparatus according to claim 1, characterized in that
the image processing section, the display section and the operation section of the dental optical diagnostic apparatus are incorporated into an dental treatment unit and the diagnostic probe having a dental handpiece-like profile and adapted to take an attitude that can be controlled vertically and transversally is arranged at the front end section of an optical fiber or signal line flexibly extending from an handpiece containing section of a tray table of the dental treatment unit, while the handpiece containing section of the dental treatment unit is equipped with a holder for removably containing the diagnostic probe.

11. The dental optical diagnostic apparatus according to claim 1, characterized in that
the apparatus further comprises OCT means for acquiring an optical tomography of the region being scanned by low coherence light or OCT means for acquiring a surface image and an optical tomography of the region being scanned, an image processing section and wireless image transmission means in the diagnostic probe having a dental handpiece-like profile, and
the diagnostic image is wirelessly transmitted to an image display section arranged at the main body of the dental optical diagnostic apparatus.

12. The dental optical diagnostic apparatus according to claim 1, characterized in that
the apparatus further comprises linearly polarizing means that includes:
a light source for generating linearly polarized low coherence light; and
linearly polarizing plate arranged on the reflection light path of linearly polarized low coherence light from the dental part, and
that extracts only the non-polarized light dissolving component.

13. The dental optical diagnostic apparatus according to claim 1, characterized in that
the apparatus further comprises linearly polarizing means that includes:
a ¼ wave plate arranged on the light path of linearly polarized low coherence light to convert linearly polarized light into circularly polarized light;
a polarization beam splitter for dividing circularly polarized light into linearly polarized lights that are orthogonal relative to each other;
a ¼ wave plate arranged on a reference light path to convert linearly polarized light from the polarization beam splitter into circularly polarized light;
a ¼ wave plate arranged on the reflection light path to convert linearly polarized light from the polarization beam splitter into circularly polarized light; and
a linearly polarizing plate arranged in a close proximity of the ¼ wave plate, and
that extracts only the non-polarized light dissolving component.
